(19) United States
(12) Patent Application Publication
(10) Pub. No.: US 2025/0083536 A1
(43) Pub. Date: Mar. 13, 2025

(54) Electric Single-Group and Double-Group Drive Heavy Truck Train

(71) Applicant: Horizon Motor, Inc., Tucker, GA (US)

(72) Inventor: HONG-WEI JING, Duluth, GA (US)

(21) Appl. No.: 18/945,341

(22) Filed: Nov. 12, 2024

Related U.S. Application Data
(60) Provisional application No. 63/537,719, filed on Sep. 11, 2023.

(51) Int. Cl. B60L 15/20; B60L 50/60

(52) U.S. Cl. CPC B60L 15/2045; B60L 50/60; B60L 2200/28; B60L 2240/42

(57) ABSTRACT

A trailer adapted for use with an electric tractor is provided. In one embodiment, the trailer includes: a chassis comprising at least one electric drive axle, the at least one drive axle comprising at least one electric drive motor; a motor control unit (MCU) coupled to the at least one electric drive motor of the electric drive axle; a power storage device coupled to the at least one electric drive motor via the motor control unit (MCU); at least one sensor; and a vehicle control unit (VCU) coupled to the motor control unit (MCU), the power storage device, and the at least one sensor, the vehicle control unit adapted to receive an input signal from the at least one sensor and provide at least one control signal to the power storage device and the motor control unit (MCU), wherein the VCU is adapted to control the motor control unit to operate the at least one motor of the electric drive axle in a drive mode and in an energy recovery mode.

### CROSS-REFERENCE TO RELATED APPLICATIONS

This application claims the benefit of U.S. provisional application No. 63/537,719 filed 11 Sep. 2023, which is hereby incorporated by reference as though fully set forth herein.

### BACKGROUND

### Field

The instant disclosure relates to electric single-group and double-group drive heavy truck trains.

### Background

Pure electric heavy-duty truck trains, that is, pure electric tractors and at least one unpowered trailer, can reduce carbon emissions. Due to space limitation of the tractor head, the tractors have less power and a relatively short battery life, which result in a reduced mileage capacities compared to internal combustion tractor trailers over long-distance trunk lines. For example, the space limitations of a tractor head reduce the capacity for more batteries and consequently more battery life and energy storage capacity.

The driving force of the tractor head is concentrated on the rear axle of the tractor, and it is more likely to slip on roads with low adhesion, such as on snow or ice covered roads, resulting in reduced safety.

For tractors with two or more sections, as the number of trailers increases, the weight of the trailers increases, and the running resistance of the train increases. The driving force of the tractor cannot meet the requirements of the maximum gradient and speed, and the train cannot be towed.

### BRIEF SUMMARY

In one embodiment, a pure-electric heavy-duty truck drive system is provided. On the basis of a pure electric tractor drive, a drive axle is added to the trailer, and an electric drive shaft is added to the trailer. The additional drive axle and drive shaft of the trailer increases the available driving force of the train. This can provide sufficient force to meet the driving force requirements of a multi-trailer train. At the same time, the trailer can be driven in accordance with demand, and load different power to solve the problem of short mileage.

In one embodiment, a synchronous and coordinated energy feedback mechanism of the tractor and trailer is provided and improves braking safety and reduces energy consumption.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a schematic diagram of a tractor trailer comprising a pure-electric tractor and a trailer.

FIG. 2 shows an embodiment of a multiple-trailer tractor trailer configuration.

FIG. 3 shows another embodiment of a multiple-trailer tractor trailer configuration.

FIG. 4 illustrates an embodiment of a trailer electric control system such as for use in the tractor trailer configurations of FIGS. 1, 2, and 3.

FIG. 5 illustrates a block diagram of an example control system for an electric drive system such as those shown in FIGS. 1, 2, and 3

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

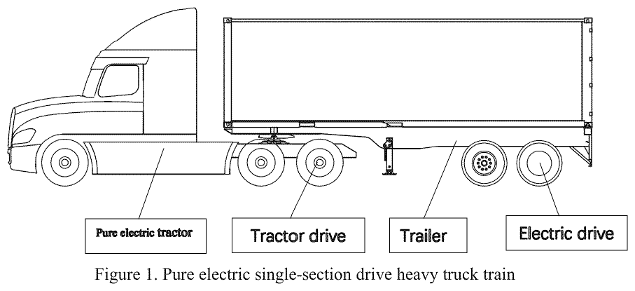

FIG. 1 shows a schematic diagram of a tractor trailer comprising a pure-electric tractor and a trailer. The tractor comprises a tractor drive axle. The trailer comprises an electric drive system. The trailer electric drive system comprises a controller, power storage (e.g., one or more batteries), and at least one trailer drive axle that is adapted to work in conjunction with the tractor drive axle.

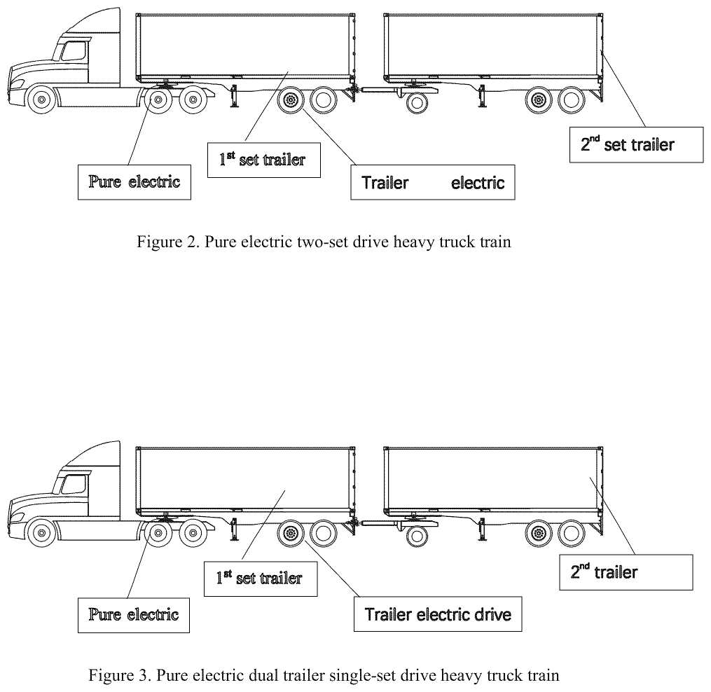

FIG. 2 shows an embodiment of a multiple-trailer tractor trailer configuration. In this embodiment, the tractor trailer comprises a pure-electric tractor, a plurality of trailers, and one or more electric trailer drive system. In this particular embodiment, for example the tractor trailer comprises a pure-electric tractor and two powered trailers. The tractor comprises a tractor drive axle as described above with reference to FIG. 1. The first trailer and the second trailer each comprise a trailer electric drive system. Each trailer electric drive system comprises a controller, a power storage (e.g., one or more batteries), and at least one trailer drive axle that is adapted to work in conjunction with the tractor drive axle.

FIG. 3 shows another embodiment of a multiple-trailer tractor trailer configuration. In this embodiment, the tractor trailer comprises a pure-electric tractor, a plurality of trailers, and one or more electric trailer drive system. In this particular embodiment, for example the tractor trailer comprises a pure-electric tractor, one powered trailer, and a second un-powered trailer. The tractor comprises a tractor drive axle as described above with reference to FIGS. 1 and 2. The first trailer comprises a trailer electric drive system. The first trailer electric drive system comprises a controller, a power storage (e.g., one or more batteries), and at least one trailer drive axle that is adapted to work in conjunction with the tractor drive axle. The second trailer comprises an unpowered trailer that is coupled behind the first powered trailer.

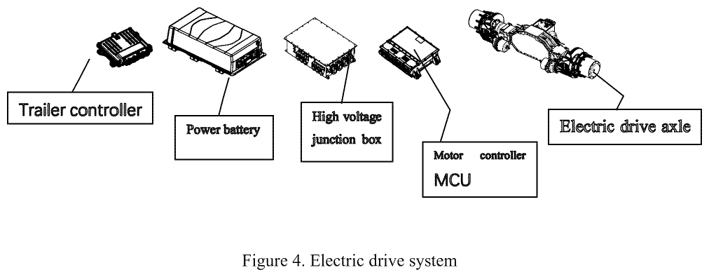

FIG. 4 shows an embodiment of a trailer electric control system, such as shown in FIGS. 1, 2 and 3. In this embodiment, for example, the trailer electric control system comprises a trailer controller (e.g., a vehicle control unit (VCU)). The controller is adapted to receive one or more inputs and provide one or more control signals as outputs to other components of the trailer electric drive system.

In one embodiment, for example, the trailer controller VCU provides a central control unit of the trailer and serve as a core of the trailer drive system. The trailer controller VCU provides the overall primary level of control for the trailer control system. The trailer controller can be adapted to collect batter (or other power and/or energy storage) and motor status (e.g., via the motor controller MCU), train acceleration and slope, various sensor signals, analyze driving intentions, monitor one or more status of each controller in a lower layer (e.g., one or more MCU's) and be responsible for normal driving, braking energy recover of trailers, drive system management, energy management, network management, fault diagnostics and processing, and vehicle status monitoring.

The trailer electric drive system comprises a power source, such as one or more batteries, and a high-voltage junction box.

A motor controller (MCU) is coupled to an electric drive axle and controls one or more operations of the electric drive axle comprising one or more electric motors adapted to drive the electric drive axle. The MCU is further coupled to the power source via the high-voltage junction box.

The trailer controller VCU receives one or more inputs from the components of the trailer electric drive system and provides one or more control signals to one or more components of the trailer electric drive system, such as the motor controller MCU.

The motor controller MCU receives the one or more control signals from the trailer controller VCU and controls one or more operations of the electric drive axle.

In one embodiment for example, the trailer controller VCU and motor controller MCU operate in conjunction to control the trailer electric system operation as follows. When the vehicle starts, accelerates, and climbs a slope, the trailer electric drive system provides power to supplement the power provided by the tractor drive system and increases the power of the overall tractor trailer train.

In contrast, when the vehicle goes downhill, or releases the accelerator on a flat road, the trailer stops the power supply to the trailer electric drive axle motor, and the trailer drive motor gives priority to energy recovery. For energy recovery, the motor controller MCU controls the motor to convert mechanical energy into electrical energy, which is stored in the power storage (e.g., one or more battery).

When the tractor brake is engaged, the energy recovery and brake together provide a braking force, which increases the braking force of and reduces thermal degradation of the friction plate of the brakes.

The driving force of the trailer is supplemented by the power of the tractor, and the tractor is regularly in a state of providing a pulling force on the trailer. The power between the tractor and the one or more powered trailers can be adjusted in real time according to the power and running status of the vehicle to balance the comprehensive power consumption of the tractor and the one or more powered trailers, and then provide driving forces. In this manner, mileage of the tractor trailer train may be increased and/or optimized.

During a downhill phase, the energy recovery and braking system of the trailer keeps the trailer electric drive axle pulling the trailer at all times to improve safety.

In one embodiment, the trailer controller VCU is linked to the tractor to control the train. The trailer is equipped with power storage (e.g., one or more batteries), and the power may be adapted to the total running mileage power requirements or specifications for a specific application.

The trailer drive system increases the power of the train. Although embodiments shown in FIGS. 2 and 3 show a single drive axle per trailer, one or more additional drive axles may be provided for one or more additional trailers, such as to provide additional power and/or energy recovery for additional loads.

The trailer electric drive system further provides an energy feedback system in which the vehicle operates in an energy recovery stage. In the energy recovery stage, the drive motor is converted to a generator under control of a motor controller MCU to provide energy recovery in which energy generated by the motor operating as a generator is stored in one or more batteries for later use in a driving mode.

In one embodiment, for example the space for power installation is increased, and the driving distance is correspondingly increased. The multi-group train provides increased driving force of the traction head and aids in efficiency.

The multi-group train can further improve operational efficiency, save drivers, and reduce transportation costs. The friction utilization rate of the road surface is improved, and the trailer and tractor work synchronously, which reduces wear of the tires.

The trailer energy recovery system can replace the retarder, improves the braking ability, improves safety, and improves economy at the same time.

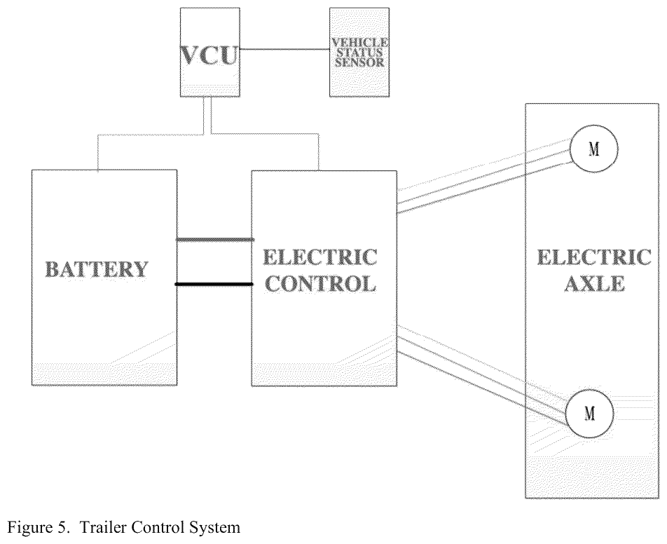

FIG. 5 is a block diagram of an example control system for an electric drive system such as those shown in FIGS. 1, 2, and 3. In this embodiment, the trailer controller VCU can be coupled and be in communication with the tractor controller. The trailer controller VCU serves as the primary controller for the trailer and controls one or more drive motors/axles for the trailer.

The trailer controller VCU coupled to a vehicle status monitor unit or vehicle status sensor(s) for receiving one or more inputs, such as from one or more sensors on the trailer. In one embodiment, for example, the trailer controller may be adapted to receive inputs, such as, but not limited to, battery status, electric control status, vehicle monitoring status, from one or more components of the trailer electric drive system.

The trailer controller VCU is further adapted to process these input(s) and provide one or more control signals to other components of the trailer electric drive system. In this embodiment, for example, the trailer controller VCU coupled to the battery and the motor controller MCU. The trailer controller VCU is adapted to control the battery and the motor controller MCU via one or more control signals via the communications connections shown.

The motor controller MCU operates under one or more control signals received from the trailer controller VCU and controls the operations of the motor(s) of the electric drive axle as described above. The motor controller MCU, for example, may control the operation of the one or more motors of the electric drive axle via one or more control signals such as a torque control signal, a speed control signal, a mode control signal (e.g., drive mode or energy recovery mode), or the like.

What is claimed is:

1. A trailer adapted for use with an electric tractor, the trailer comprising:
a chassis comprising at least one electric drive axle, the at least one drive axle comprising at least one electric drive motor;
a motor control unit (MCU) coupled to the at least one electric drive motor of the electric drive axle;
a power storage device coupled to the at least one electric drive motor via the motor control unit (MCU);
at least one sensor; and
a vehicle control unit (VCU) coupled to the motor control unit (MCU), the power storage device, and the at least one sensor, the vehicle control unit adapted to receive an input signal from the at least one sensor and provide at least one control signal to the power storage device and the motor control unit (MCU), wherein the VCU is adapted to control the motor control unit to operate the at least one motor of the electric drive axle in a drive mode and in an energy recovery mode.

2. The trailer of claim 1, wherein the power storage device comprises at least one battery.

3. The trailer of claim 1, wherein the drive mode comprises the motor control unit (MCU) controlling the at least one motor of the electric drive axle to provide power to the electric drive axle.

4. The trailer of claim 3, wherein the energy recovery mode comprises the motor control unit (MCU) controlling the at least one motor of the electric drive axle to operate as a generator and provide power to the power storage device.
